(19) United States
(12) Patent Application Publication
(10) Pub. No.: US 2013/0232769 A1
(43) Pub. Date: Sep. 12, 2013

(54) Wallgrip screw

(71) Applicant: Orlando Wooten, Calumet City, IL (US)

(72) Inventor: Orlando Wooten, Calumet City, IL (US)

(21) Appl. No.: 13/374,240

(22) Filed: Mar. 9, 2012

(51) Int. Cl. F16B 35/00; B23P 11/00; F16B 23/00

(52) U.S. Cl. 29/525.11; 411/389

(57) ABSTRACT

A fastener for securing drywall to wood or metal substrate. The fastener includes a dual threaded head drywall fastener with hexagon driving collar. The longer threaded side of fastener is driven directly into wood or metal substrate, the driving collar acts as a stopper, leaving the shorter threaded fastener side protruding from the wood or metal substrate. The shorten; threaded fastener side comes in direct contact with the drywall, by piercing and penetrating the unfinished side of drywall into fastener. The shorten side of fastener does not come threw the drywall finished side, forming a gripping effect to the paper and gypsum without damaging the finished side of the drywall.

### RELATED APPLICATION

This application is a continuation in part of application Ser. No. 13/374,240 which was filed on Dec. 19, 2011 for “The Wallgrip Screw” by applicant of this application.

### FIELD OF THE INVENTION

The present invention relates generally to fastener and more particularly to securing drywall to wood or metal substrate, by pushing drywall into dual threaded fastener heads, from the inner or unfinished surface of the drywall. Penetrating the paper and gypsum producing a holding action, but not exiting or penetrating threw the finish side of the drywall.

### BACKGROUND OF THE INVENTION

Fasteners for attachment of drywall (gypsum board) to a metal substrate are, generally helically threaded round screw bodies or round nail shanks (center shanks). The center shanks of these type fasteners penetrate the top paper of the drywall paper-gypsum-paper laminate then the head countersinks into the top paper laminate to such a distance as to be flush or slightly below flush with the top surface. It is necessary for ultimate strength of drywall board fastening that the top paper laminate not be cut around the perimeter of the head. If this situation occurs it is not within building code specifications.

It has been discovered that the central shank of both types of conventional fasteners used for this application (screws and nails) cut this top paper laminate. This is obvious, but what is not obvious is that this allows the paper to stretch as the head perimeter to countersink into the gypsum without cutting through the top paper laminate. Additionally, the head of these fasteners are rounded on their edges to eliminate a sharp edge.

The present invention incorporates a structure to allow a fastener with dual threaded head drywall fastener with a driving collar to allow the longer side to penetrate a wood or metal substrate and the shorter side to penetrate the unfinished side of the drywall without coming threw the finished side of the drywall.

### SUMMARY OF INVENTION

A fastener for securing drywall having a paper laminate to a wood or metal substrate, including a point for penetrating the drywall and the wood or metal substrate. The securing member of the drywall is the shorten end of the dual threaded head drywall fastener. The longer side the dual threaded head drywall fastener with hexagon driving collar is driven directly into the wood or metal substrate. Using a standard ¼ inch or 6 mm hexagon socket. The drywall's unfinished side is pushed directly into the shorter end of the dual threaded head drywall fastener with hexagon driving collar, penetrating paper and gypsum causing a gripping affect to the substrate.

### BRIEF DESCRIPTION OF DRAWINGS

FIG. 1.—Is a perspective view of a fastener constructed in accordance with the principles of the present invention: Also it's a partial plan view of an alternative embodiment of the driving collar of a fastener constructed in accordance with the present invention.

FIG. 2.—Is a cross sectional view illustrating the hexagon driving collar.

### DETAILED DESCRIPTION

A fastener constructed in accordance with the present invention includes a body which penetrates both the drywall and the metal or wood substrate with a minimum of effort. The longer side of the dual threaded head drywall fastener with hexagon driving collar is driven through the wood or metal substrate by and appropriate power tool preferably a pneumatically operated power tool which has a work stroke such that the body of the fastener penetrates through the wood or metal substrate. By amounts sufficient to cause the driving collar of the fastener to be positioned substantially flushed with the wood or metal substrate. The shorter side of the dual threaded head drywall fastener with hexagon driving collar protrudes outside the wood or metal substrate, causing a gripping affect when the unfinished side of the drywall is pushed into threaded head of dual threaded head drywall fastener with hexagon driving collar.

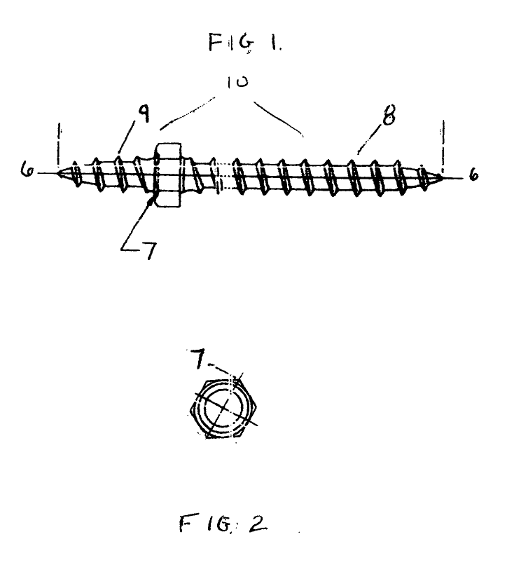

A cutting or piercing point 6 surface is provided on both heads of the fastener to penetrate the drywall and the wood or metal substrate. As is shown, in FIG. 1, the fastener 10 includes an elongated body 9 having a dual point 6 at opposite ends of the body for penetrating the drywall and the wood or metal substrate. The securing member is carried by the body for securing the drywall and the wood or metal substrate, the threaded heads 8 on opposite ends of the body protrudes upwardly toward the hexagon collar for piercing and penetrating the drywall on the shorten end and the longer end for wood or metal substrate.

As shown in FIG. 2 the fastener is driven through the wood or metal substrate by an appropriate power tool preferably a pneumatically operated power tool with a hexagon socket, which the dual threaded head drywall fastener with hexagon driving collar 7 is inserted, the long end pointed outward, the fastener penetrates through the wood or metal substrate causing the hexagon drive collar 7 to be positioned substantially flush with the wood or metal substrate. The shorten thread head body 9 is protruding from substrate with point 6 ready to pierce and penetrate drywall for gripping effect to substrate.

What is claimed is:

1. A fastener for securing a drywall piece having a paper laminate to a wood or metal substrate: an elongated round threaded body including a dual point for penetrating said drywall and said substrate. A hexagon driving collar ⅜ inch from point of fastener.
a securing member carried by said body.
a dual threaded head for which one side of said longer body is driven by the collar in the said substrate, and the shorten threaded body pierce and penetrate the laminated drywall causing a gripping effect.

2. A fastener for securing a drywall piece having a paper laminate to a wood or metal substrate.
A dual threaded head fastener with hexagon driving collar, is inserted into a ¼ inch hexagon socket connected to a power tool, the hexagon drive collar drives the longer threaded head of the fastener into the wood or metal substrate, leaving the shorter threaded head exposed leaving the collar flush with wood or metal substrate. The drywall is pushed directly on the shorten threaded head, piercing and penetrating the drywall causing a gripping effect.
